(19) United States
(12) Patent Application Publication
(10) Pub. No.: US 2020/0142511 A1
(43) Pub. Date: May 7, 2020

(54) DISPLAY CONTROL DEVICE AND DISPLAY CONTROL METHOD

(71) Applicant: Mitsubishi Electric Corporation, Tokyo (JP)

(72) Inventor: Akiko WATANABE, Tokyo (JP)

(73) Assignee: Mitsubishi Electric Corporation, Tokyo (JP)

(21) Appl. No.: 16/609,972

(22) PCT Filed: Jul. 27, 2017
(86) PCT No.: PCT/JP2017/027225

§ 371 Date: Oct. 31, 2019

(51) Int. Cl. G06F 3/041; G06F 3/0484; G06F 3/0488

(52) U.S. Cl. CPC G06F 3/041; G06F 3/0488; G06F 3/0484

(57) ABSTRACT

A display control device includes a first display control unit that displays an image on a touch panel, a second display control unit that displays an image in a visual field of an operator of the touch panel using a head-up display, and an indicator position recognition unit that recognizes the position of the indicator used for an operation of the touch panel. The first display control unit includes an operation button position control unit that controls a display position of an operation button in the touch panel. The operation button position control unit brings the display position of the operation button close to an indicator when the indicator approaches the touch panel. The second display control unit displays a synthesized image of an image being displayed on the touch panel and an image indicating the position of the indicator in the visual field of the operator.

### TECHNICAL FIELD

The present invention relates to a display control device that displays an image on a touch panel and a head-up display.

### BACKGROUND ART

Information processing devices that can be operated using a touch panel have become widespread. For example, in an information processing device mounted on a vehicle, such as a navigation device, a touch panel is disposed on the center panel of the many vehicles, and a driver has had difficulty in operating such a touch panel while driving the vehicle.

For example, the cited Document 1 below discloses a display device that controls the position of an operation button to be displayed on a touch panel in accordance with the position of an operator's finger. In the display device of cited

Document 1, the priority is set for each operation button in accordance with the number of past operations, and when the operator's finger is approaches the touch panel, the operation button with high priority is displayed near the operator's finger. Thereby, the operability of the touch panel is improved.

Also in recent years, a head-up display (HUD) that can directly display an image in the visual field of the driver by using a windshield or the like that can be seen through by the driver of the vehicle as a display screen has been put into practical use. The image displayed by the head-up display can be viewed with the driver looking toward the front of the vehicle.

### PRIOR ART DOCUMENTS

### Patent Documents

[Patent Document 1] Japanese Patent Application Laid-Open No. 2011-198210

### SUMMARY

### Problem to be Solved by the Invention

According to the technique of Patent Document 1, since the operation buttons are displayed near the operator's finger on the screen of the touch panel, the operability of the touch panel is improved. However, the operator needs to look at the touch panel in order to check which operation button is displayed near the finger.

The present invention has been made to solve the problems as described above, an object of the present invention is to improve the operability of the touch panel and allow the operator to operate the operation buttons without looking at the touch panel.

### Means to Solve the Problem

A display control device according to the present invention, includes a first display control unit configured to display an image on a touch panel, a second display control unit configured to display an image in a visual field of an operator of the touch panel using a head-up display, and an indicator position recognition unit configured to recognize a position of an indicator used for an operation of the touch panel. The first display control unit includes an operation button position control unit configured to control a display position of an operation button when the operation button is displayed on the touch panel. When a distance between the touch panel and the indicator becomes smaller than a predetermined threshold value, the operation button position control unit is configured to bring the display position of the operation button close to the position of the indicator. The second display control unit is configured to display a synthesized image of an image being displayed on the touch panel and an image indicating the position of the indicator in the visual field of the operator using the head-up display.

### Effects of the Invention

According to the present invention, when the indicator approaches the touch panel, the operation buttons are displayed in the vicinity of the position of the indicator; therefore, the operability of the touch panel is improved. Further, since the operator can grasp the positional relationship between the indicator and the operation button from the image displayed on the head-up display, the operator can operate the operation button without looking at the touch panel.

These and other objects, features, aspects and advantages of the present invention will become more apparent from the following detailed description of the present invention when taken in conjunction with the accompanying drawings.

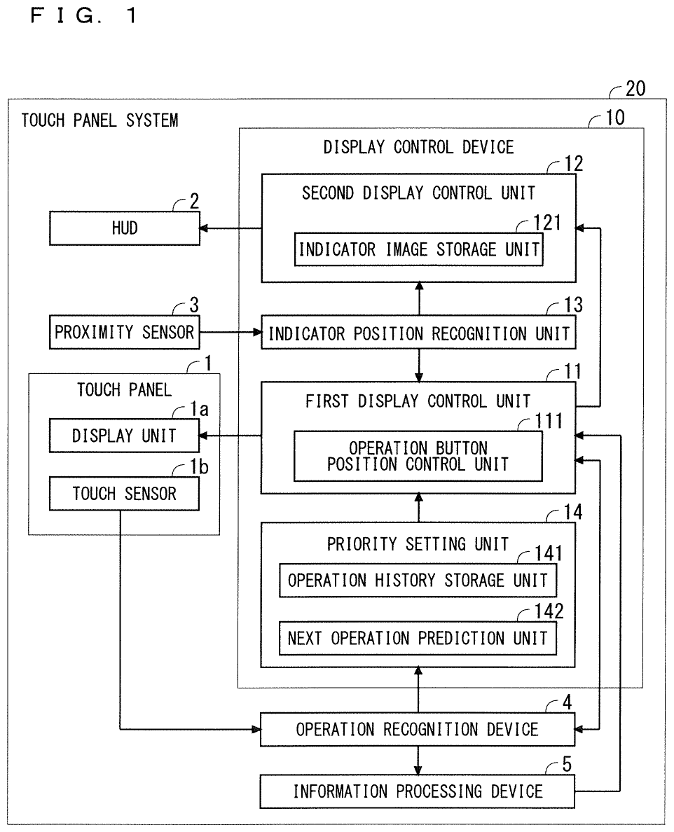

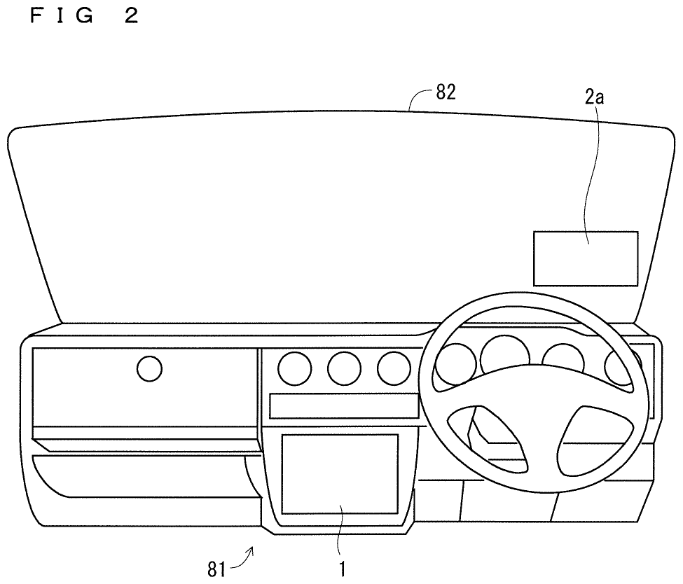

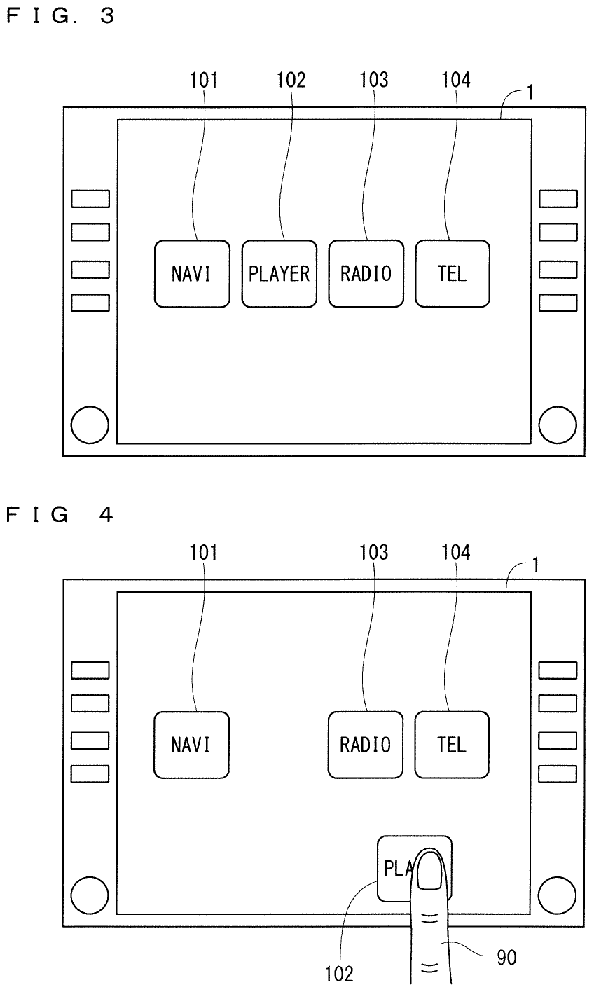

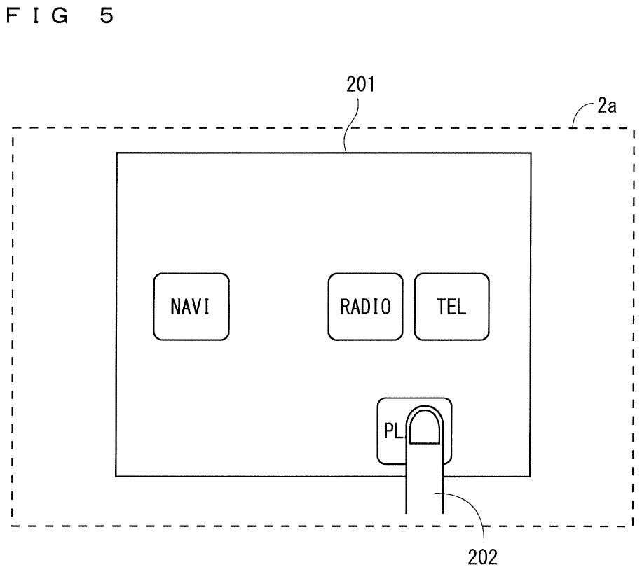

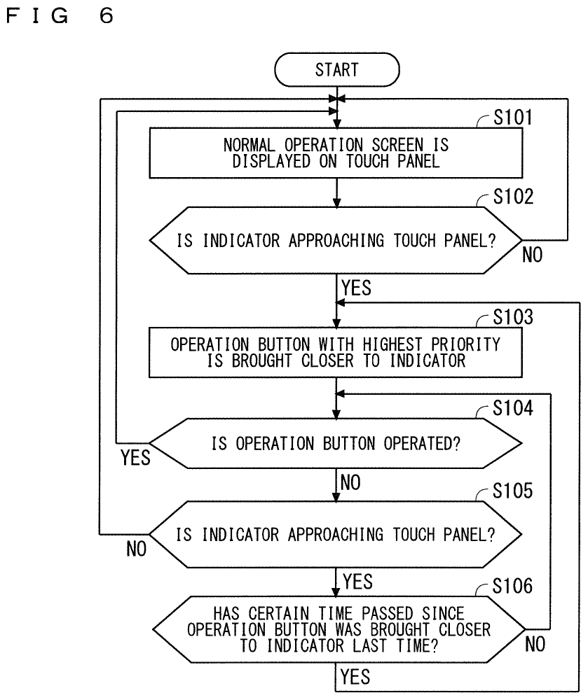

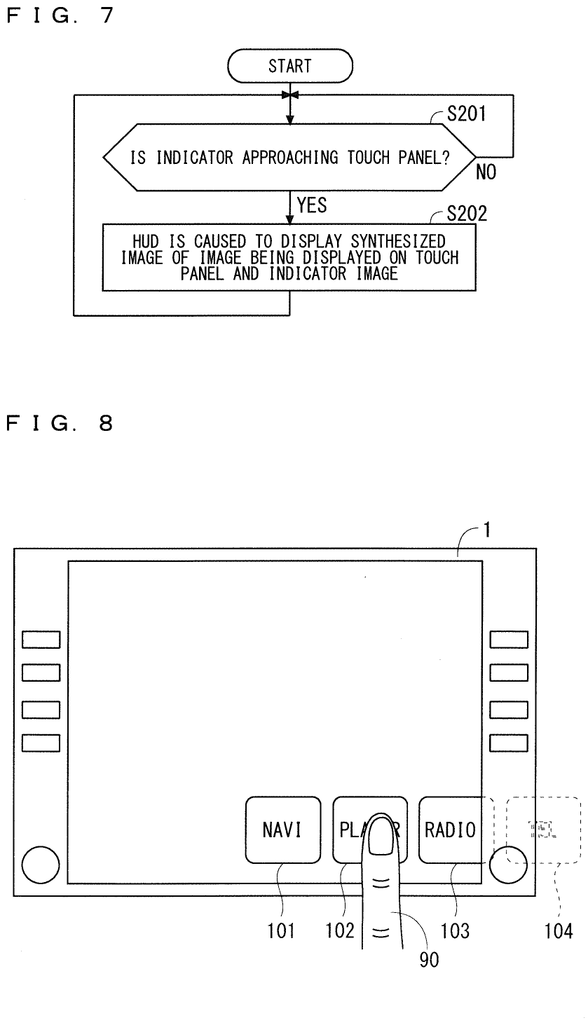

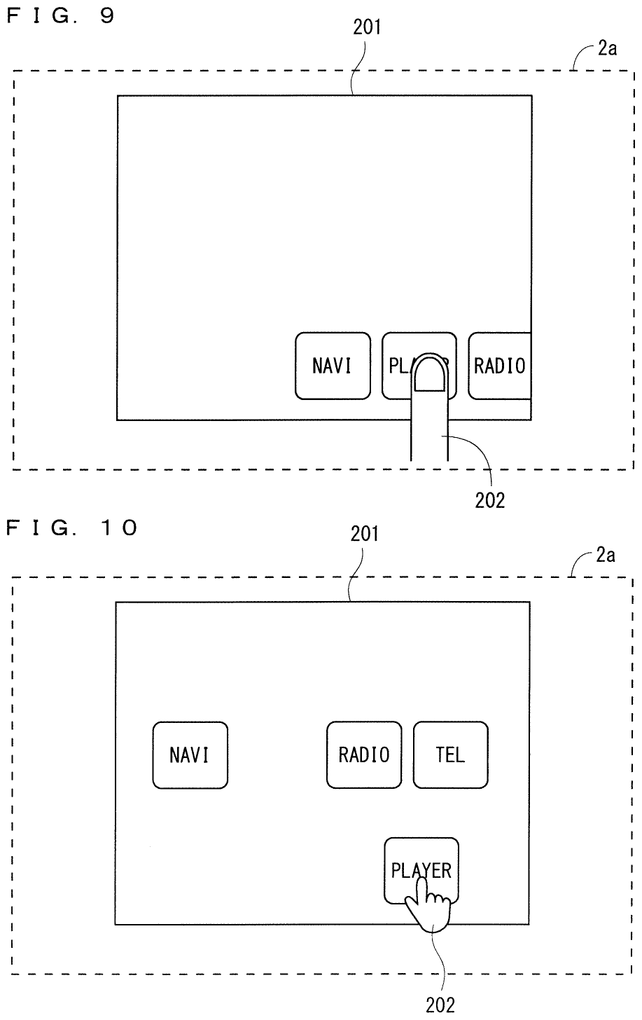

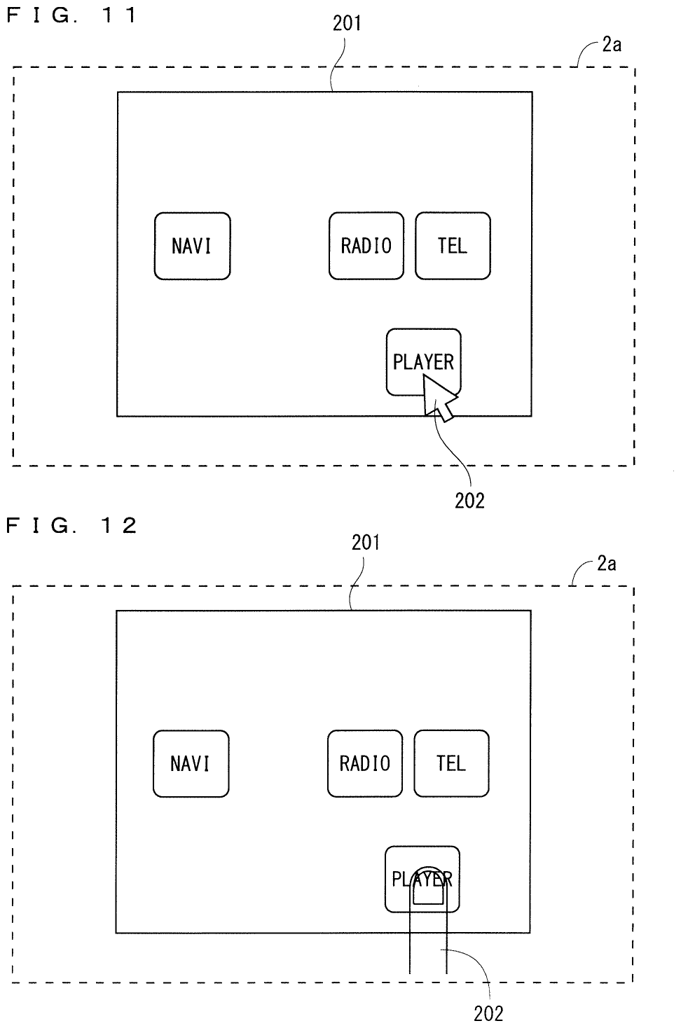

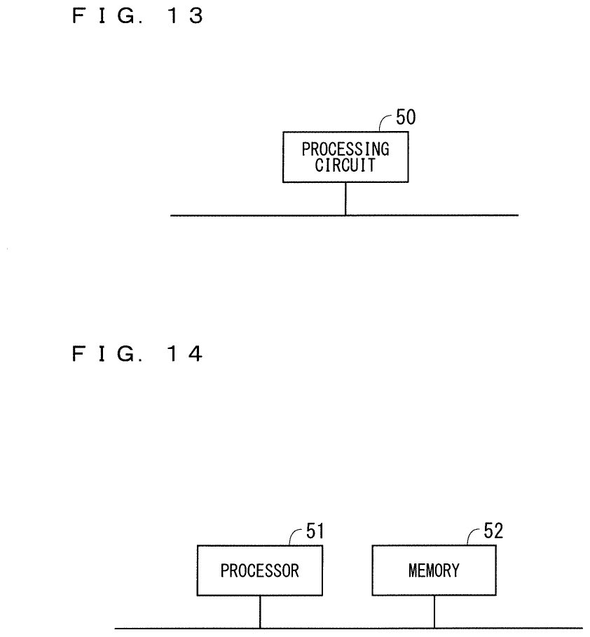

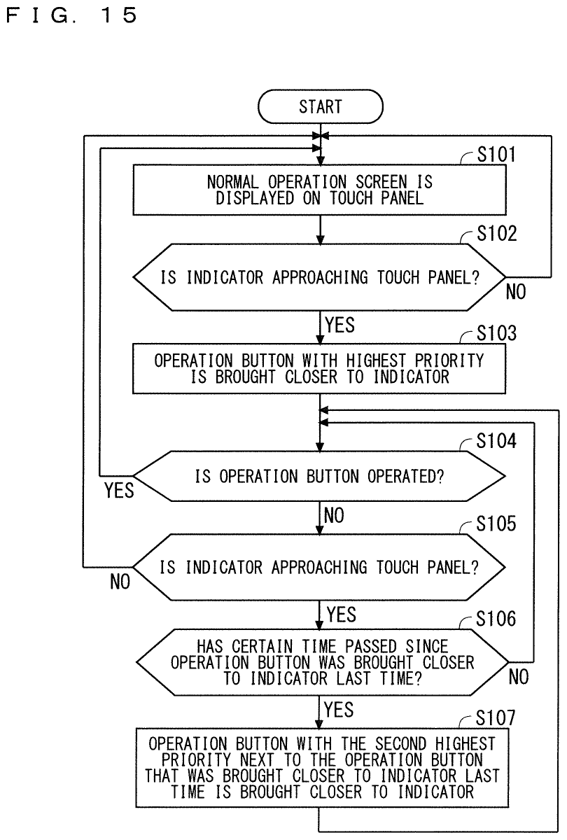

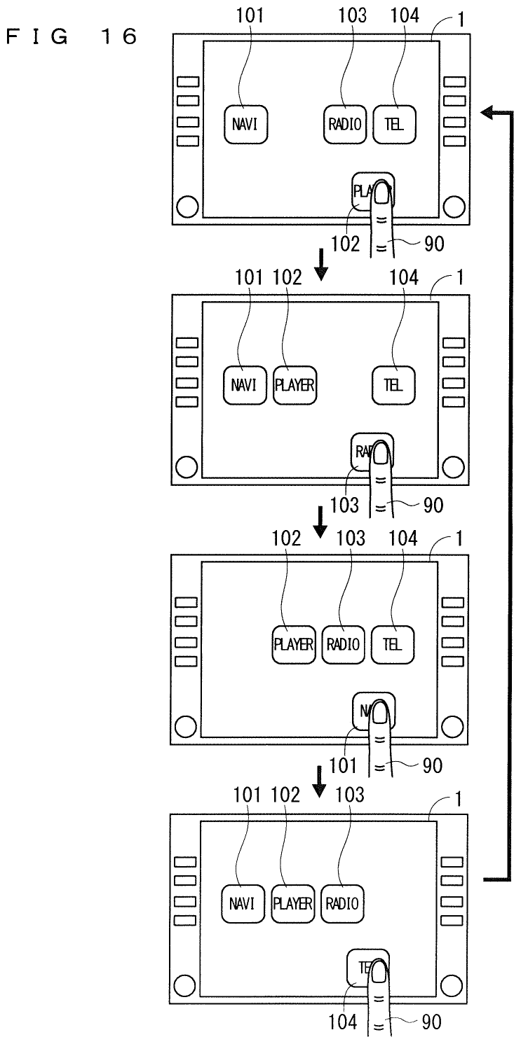

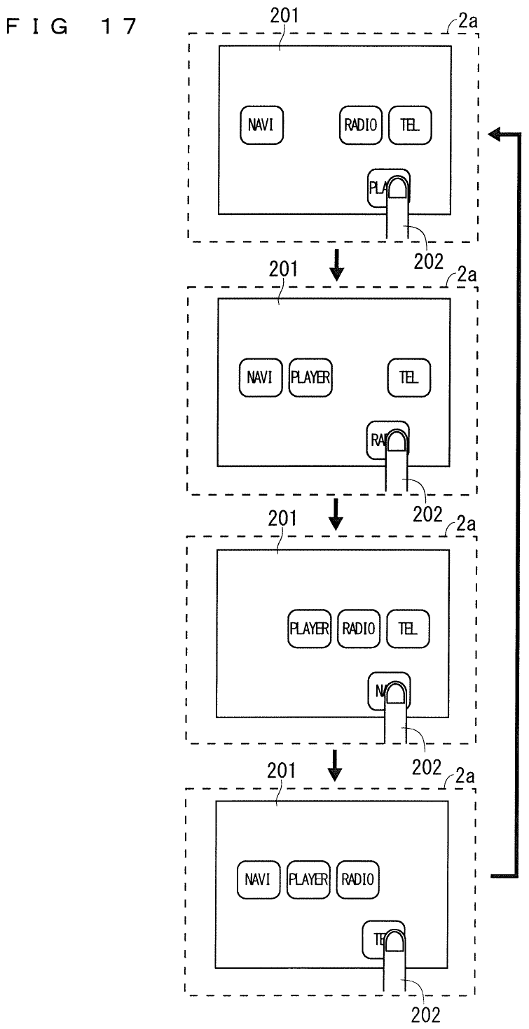

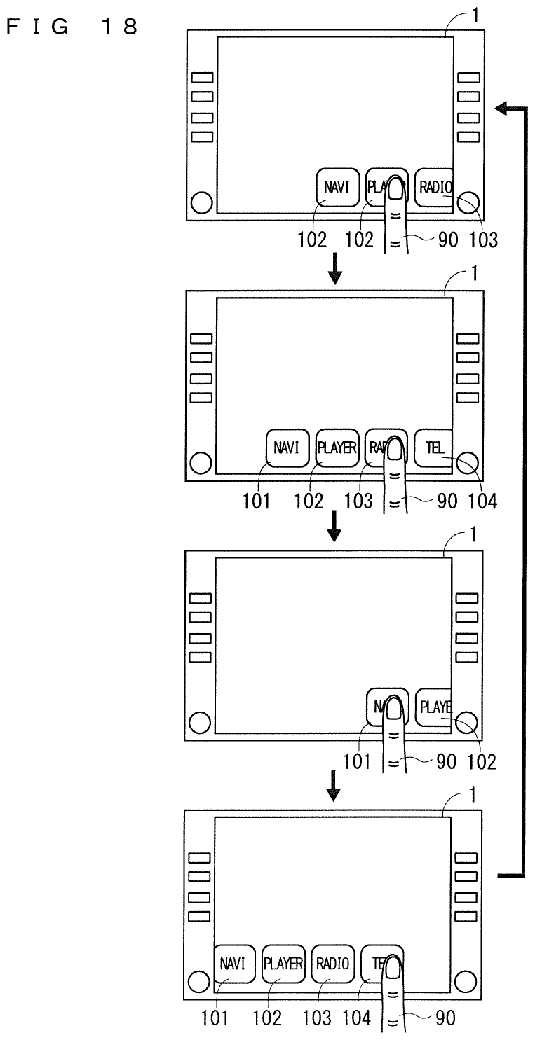

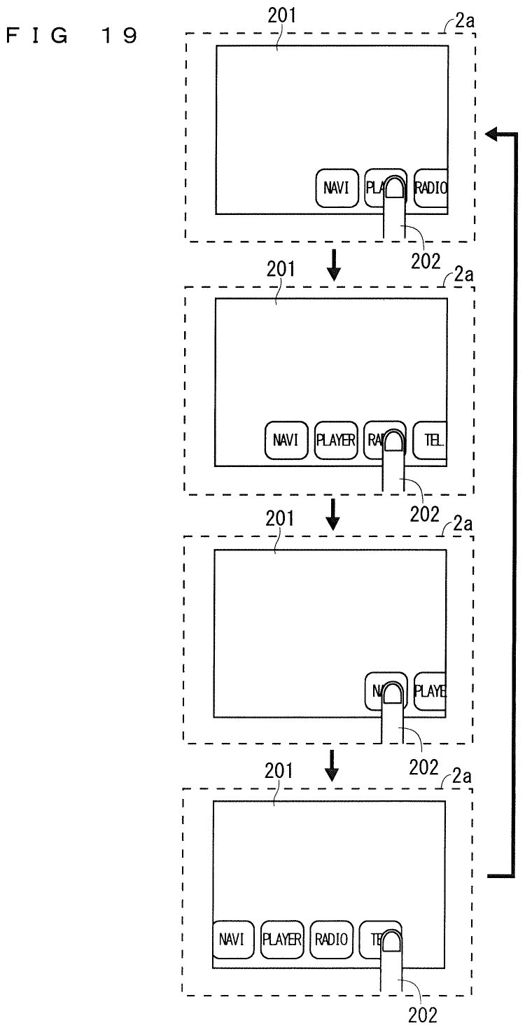

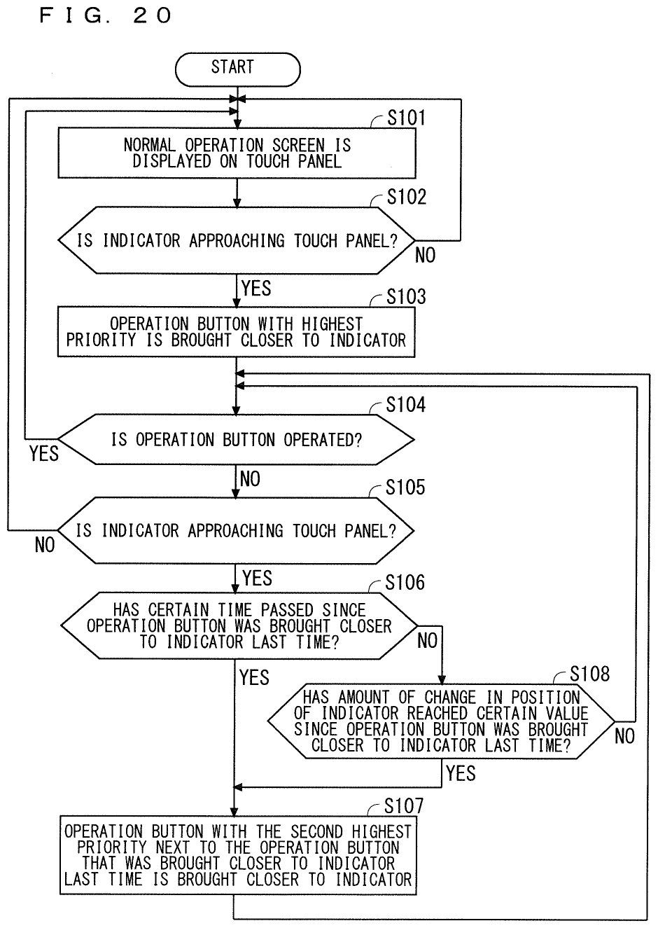

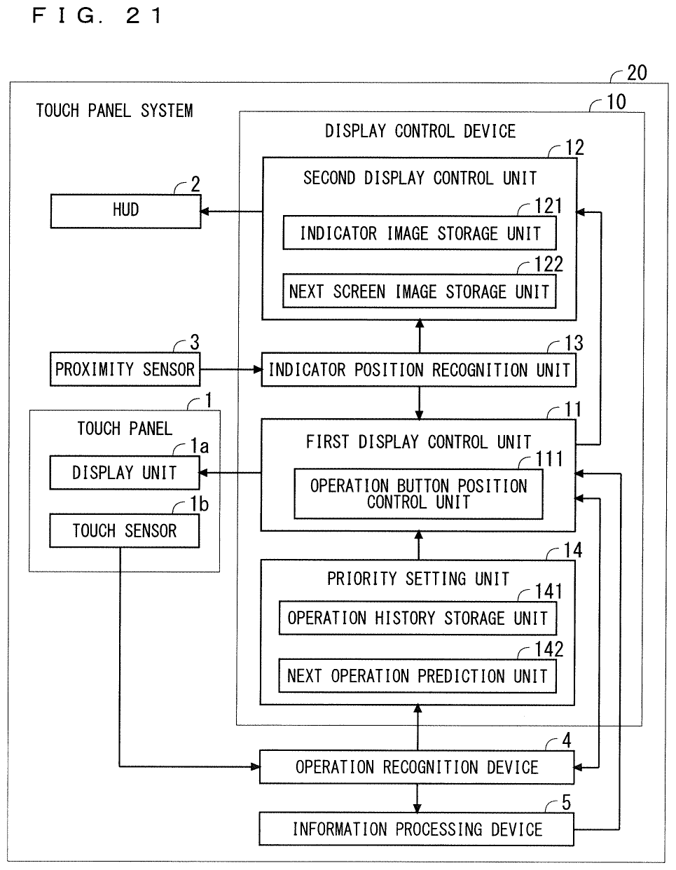

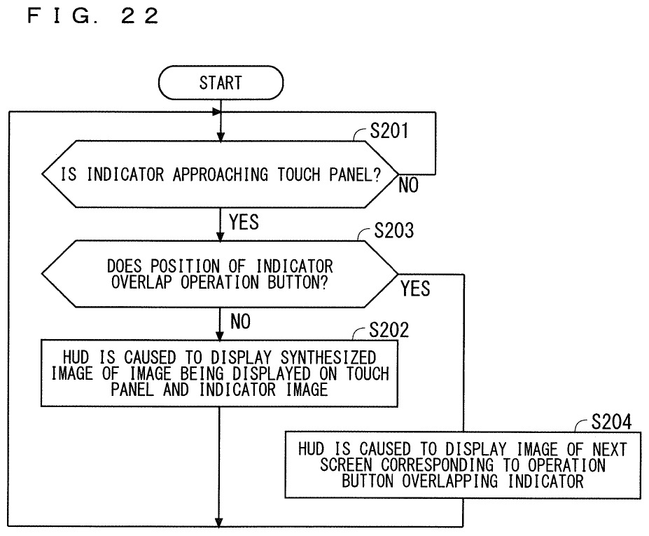

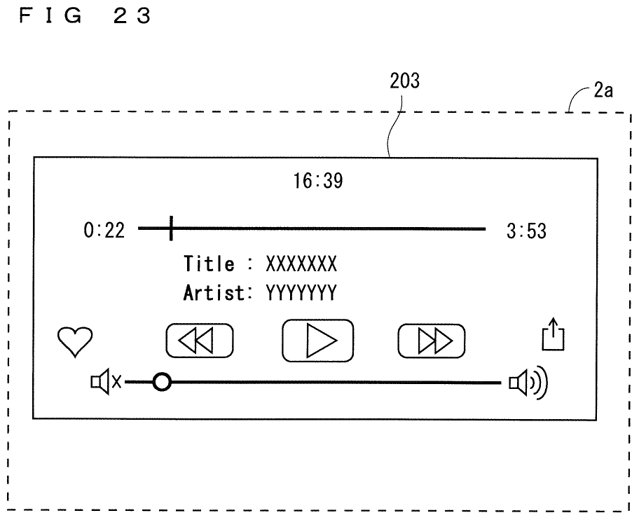

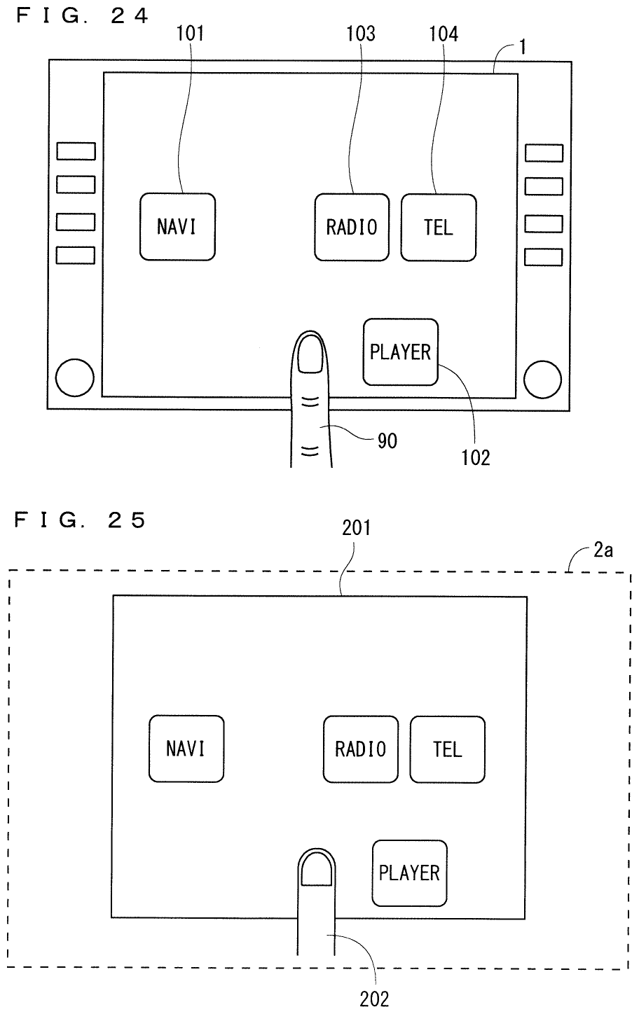

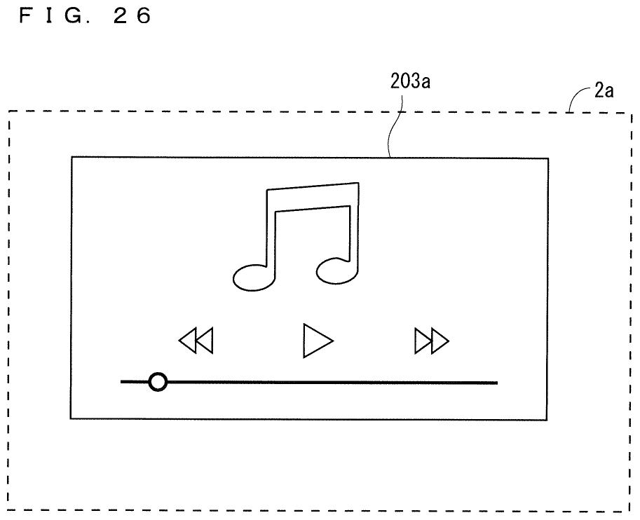

### BRIEF DESCRIPTION OF DRAWINGS

[FIG. 1] A functional block diagram illustrating a configuration of a touch panel system according to Embodiment 1.

[FIG. 2] A diagram illustrating an example of arrangement of a display area of a touch panel and a head-up display.

[FIG. 3] A diagram illustrating an example of an operation screen displayed on the touch panel.

[FIG. 4] A diagram illustrating an example of an operation screen displayed on the touch panel. [FIG. 5] A diagram illustrating an example of an image the head-up display displays.

[FIG. 6] A flowchart illustrating an operation of a first display control unit according to Embodiment 1.

[FIG. 7] A flowchart illustrating an operation of a second display control unit according to Embodiment 1.

[FIG. 8] A diagram illustrating an example of an operation screen displayed on the touch panel.

[FIG. 9] A diagram illustrating an example of an image the head-up display displays.

[FIG. 10] A diagram illustrating Modification of an indicator image.

[FIG. 11] A diagram illustrating Modification of an indicator image.

[FIG. 12] A diagram illustrating Modification of an indicator image.

[FIG. 13] A block diagram illustrating an example of a configuration of hardware of a display control device.

[FIG. 14] A block diagram illustrating an example of a configuration of hardware of a display control device.

[FIG. 15] A flowchart illustrating an operation of a first display control unit according to Embodiment 2.

[FIG. 16] A diagram illustrating an example of changes of operation screens displayed on the touch panel.

[FIG. 17] A diagram illustrating an example of changes of images the head-up display displays.

[FIG. 18] A diagram illustrating an example of changes of operation screens displayed on the touch panel.

[FIG. 19] A diagram illustrating an example of changes of images the head-up display displays.

[FIG. 20] A flowchart illustrating an operation of a first display control unit according to Embodiment 3.

[FIG. 21] A functional block diagram illustrating a configuration of a touch panel system according to Embodiment 4.

[FIG. 22] A flowchart illustrating an operation of a second display control unit according to Embodiment 4.

[FIG. 23] A diagram illustrating an example of an image the head-up display displays.

[FIG. 24] A diagram illustrating an example of an operation screen displayed on the touch panel.

[FIG. 25] A diagram illustrating an example of an image the head-up display displays.

[FIG. 26] A diagram illustrating an example of a simplified next screen image.

### DESCRIPTION OF EMBODIMENTS

<Embodiment 1>

FIG. 1 is a functional block diagram illustrating a configuration of a touch panel system 20 according to Embodiment 1. As illustrated in FIG. 1, the touch panel system 20 includes a touch panel 1, a head-up display (HUD) 2, a proximity sensor 3, an operation recognition device 4, an information processing device 5, and a display control device 10.

In Embodiment 1, it is assumed that touch panel system 20 is mounted on a vehicle. However, the touch panel system 20 is not necessarily permanently installed in a vehicle, and can be applied to, for example, a portable device that can be brought into a vehicle.

The touch panel 1 includes a display unit 1a that displays an image and a touch sensor 1b disposed on the screen of the display unit 1a. The touch sensor 1b detects a position (coordinates) where an operator (vehicle driver) touches the screen of the display unit 1a. In order to simplify the description, the display unit la and the touch sensor 1b are collectively referred to as “touch panel 1” below. For example, an image displayed on the display unit 1a is referred to as an “image displayed on the touch panel 1”, and an operation on the touch sensor 1b is referred to as an “operation on the touch panel 1”.

The head-up display 2 is a display device that directly displays an image in the driver's visual field by displaying the image on a display screen that the driver of the vehicle can see therethrough. In Embodiment 1, although the head-up display 2 uses a vehicle windshield as a display screen, a small transparent plastic disk called a “combiner” may be used as a display screen, for example.

FIG. 2 illustrates an example of a front panel 81 and a windshield 82 of a vehicle on which the touch panel system 20 is mounted. In the example of FIG. 2, the touch panel 1 is arranged in the central portion (center panel) of the front panel 81 of the vehicle, and the display area 2a of the head-up display 2 is arranged on an end portion of the driver's seat side (right side in FIG. 2) of the windshield 82 of the vehicle. Arrangement of the touch panel 1 and the display area 2a of the head-up display 2 is not limited to the example of FIG. 2.

The proximity sensor 3 detects the position of an indicator used for the operation of the touch panel 1 and the distance of the indicator from the touch panel 1. Although, the indicator may be a stylus pen or the like held by the operator, in Embodiment 1, the indicator is a finger of the operator. In particular, in a touch panel system mounted on a vehicle, since the operator operates the touch panel while driving of the vehicle, the indicator is generally an operator's finger.

The operation recognition device 4 recognizes an operation performed by the operator using the touched panel 1 based on the touch position of the indicator detected by the touch panel 1 (touch sensor 1b). Information on the operation recognized by the operation recognition device 4 is input to the information processing device 5.

The information processing device 5 is a device that is subject to an operation using the touch panel 1. That is, the operation screen of the information processing device 5 and the execution screen of each function are displayed on the touch panel 1, and the operator can operate the information processing device 5 using the touch panel 1. The information processing device 5 may be, for example, an in-vehicle device such as a navigation device or an audio display device, or may be a portable device that can be brought into the vehicle, such as a mobile phone or a smartphone.

As illustrated in FIG. 1, the display control device 10 includes a first display control unit 11, a second display control unit 12, an indicator position recognition unit 13, and a priority setting unit 14.

The first display control unit 11 generates an image signal for displaying an image on the touch panel 1. In addition, the first display control unit 11 includes an operation button position control unit 111 that controls the display position of each operation button when the operation screen including an operation button is displayed on the touch panel 1.

The second display control unit 12 generates an image signal for displaying an image by the head-up display 2. The second display control unit 12 includes an indicator image storage unit 121 that stores in advance an image indicating the position of the indicator (hereinafter referred to as “indicator image”).

The indicator position recognition unit 13 recognizes the relative position of the indicator with respect to the touch panel 1 based on position information of the indicator (operator's finger) detected by the proximity sensor 3. The indicator position recognition unit 13 recognizes at least the distance from the touch panel 1 to the indicator and the position of the indicator on the touch panel 1 (the position of the indicator when viewed from the direction perpendicular to the touch panel 1).

The priority setting unit 14 sets the priority for each of the operation buttons included in the operation screen displayed on the touch panel 1 by the first display control unit 11. Further, the priority setting unit 14 includes an operation history storage unit 141 and a next operation prediction unit 142. The operation history storage unit 141 stores an operation history of each operation button recognized by the operation recognition device 4. The next operation prediction unit 142 learns the operation pattern of the operator based on the operation history of each operation button stored in the operation history storage unit 141, and predicts the operation button to be operated next by the operator.

The priority setting unit 14 sets the priority in accordance with probability in the next operation to each operation button based on the prediction result by the next operation prediction unit 142. That is, a high priority is set for an operation button that is likely to be operated next, and a low priority is set for an operation button that is unlikely to be operated next.

As a method of predicting the operation button to be operated next, for example, a method in which prediction is made in that among the operation buttons currently displayed on the touch panel 1, the more frequently operated, the higher the probability that it will be operated next.

When the indicator approaches the touch panel 1, the operation button position control unit 111 described above moves the display position of the operation button such that the display position approaches the position of the indicator. The determination as to whether or not the indicator has approached the touch panel 1 is carried out by determining whether or not the distance from the touch panel 1 to the indicator recognized by the indicator position recognition unit 13 has become smaller than a predetermined threshold value. Although the threshold value may be any value, it is preferably about 2 cm to 3 cm, for example.

Further, the second display control unit 12 acquires data of the image being displayed on the touch panel 1 from the first display control unit 11 when the indicator approaches the touch panel 1, synthesizes the image being displayed on the touch panel 1 and the indicator image stored in the indicator image storage unit 121, and displays the obtained synthesized image in the visual field of the operator using the head-up display 2.

Here, the operations of the first display control unit 11 and the second display control unit 12 will be described in detail. For example, assume that the information processing device 5 is an in-vehicle device having a navigation function, a media playback function, a radio playback function, and a hands-free telephone function, and when the touch panel system 20 is activated, the first display control unit 11 displays the operation screen illustrated in FIG. 3 on the touch panel 1. In the operation screen of FIG. 3, as the operation buttons, a “NAVI” button 101 for activating a navigation function, a “PLAYER” button 102 for activating a media playback function, a “RADIO” button 103 for activating a radio playback function, and a “TEL” button 104 for activating a hands-free telephone function, are included therein.

Further, assume the priority setting unit 14 assigns higher priority in the order of the PLAYER button 102, the RADIO button 103, the NAVI button 101, and the TEL button 104 based on the past operation history. That is, the operation button with the highest priority is the PLAYER button 102.

As illustrated in FIG. 4, when the operator brings a finger 90 as an indicator close to the touch panel 1, the operation button position control unit 111 of the first display control unit 11 brings the display position of the PLAYER button 102 with the highest priority close to the position of the finger 90 of the operator. The PLAYER button 102, which is highly likely to be operated by the operator, is arranged near the operator's finger, thereby improving the operability of the operation screen.

However, the operation button position control unit 111 does not allow the position of the PLAYER button 102 to follow the movement of the operator's finger 90 for a certain time after the PLAYER button 102 is moved to the vicinity of the operator's finger 90 and the PLAYER button 102 is fixed. This is because moving the PLAYER button 102 always together with the operator's finger 90 disturbs the operator to operate the operation buttons other than the PLAYER button 102.

Although in FIG. 4, an example is illustrated, in which the operation button position control unit 111 moves the display position of the operation button with the highest priority to the same position (overlapping position) as the operator's finger 90, the display position after moving the operation button with the highest priority does not necessarily be the same as the position of the indicator, and may be in the vicinity of the indicator. That is, it is sufficient that the operation button position control unit 111 only brings the display position of the operation button with the highest priority to a position close to the indicator than the original position (display position on the operation screen in FIG. 3).

Meanwhile, when the operator's finger 90 approaches the touch panel 1 and the display on the touch panel 1 changes as illustrated in FIG. 4, the second display control unit 12 displays the synthesized image of the image 201 being displayed on the touch panel 1 and the indicator image 202 stored in the indicator image storage unit 121 in the operator's (driver's) visual field (display area 2a illustrated in FIG. 2) as illustrated in FIG. 5. In FIG. 5, the indicator image 202 is an image imitating an operator's finger. The indicator image 202 is synthesized with the image 201 being displayed on the touch panel 1 at a position corresponding to the actual position of the finger 90 of the operator. Accordingly, the position of the indicator image 202 in the image 201 indicates the position of the operator's finger 90 on the touch panel 1.

The operator can grasp the positional relationship between the operation buttons displayed on the touch panel 1 and the finger 90 by looking at the image of the head-up display 2 illustrated in FIG. 5; therefore, the operator can operate the touch panel while looking ahead of the vehicle. In addition, since the operation button with higher priority is displayed near the operator's finger 90, the operability of the operation screen is improved.

FIG. 6 is a flowchart illustrating an operation of the first display control unit 11. The operation of the first display control unit 11 will be described with reference to FIG. 6. In the following description, an operation screen in a state before the operation button position control unit 111 moves the operation button (the operation screen in FIG. 3 in the above example) is referred to as a “normal operation screen”.

First, the first display control unit 11 displays a normal operation screen (for example, an operation screen as illustrated in FIG. 3) on the touch panel 1 (Step S101). Next, the operation button position control unit 111 checks whether or not the indicator approaches the touch panel 1 based on the position of the indicator recognized by the indicator position recognition unit 13 (Step S102). Specifically, the operation button position control unit 111 checks whether or not the distance from the touch panel 1 to the indicator is smaller than a predetermined threshold value.

When the indicator does not approach the touch panel 1 (NO in Step S102), the process returns to Step S101, and the normal operation screen is continuously displayed on the touch panel 1.

When the indicator approaches the touch panel 1 (YES in Step S102), the operation button position control unit 111 brings the display position of the operation button with the highest priority close to the position of the indicator (Step S103). For example, when the normal operation screen is the one illustrated in FIG. 3, the operation screen as illustrated in FIG. 4 is displayed on the touch panel 1.

In addition, the operation button position control unit 111 notifies the operation recognition device 4 of information on the moved operation button. Accordingly, the operation recognition device 4 can grasp the position of the operation button after being moved by the operation button position control unit 111.

And, the operation button position control unit 111 checks whether any of the operation buttons has been operated by the operator (Step S104). This process can be performed by checking whether or not an operation of an operation button has been detected by the operation recognition device 4.

If any of the operation buttons is operated (YES in Step S104), the first display control unit 11 returns the process to Step S101 to shift the display of the touch panel 1 to the next screen according to the operation.

When none of the operation buttons is operated (NO in Step S104), the operation button position control unit 111 checks whether or not the state where the indicator approaches the touch panel 1 is continuing (Step S105). At this time, if the indicator is away from the touch panel 1 (NO in Step S105), the first display control unit 11 returns the process to Step S101 to return the display on the touch panel 1 to the normal operation screen.

If the indicator continues to approach the touch panel 1 (YES in Step S105), the operation button position control unit 111 checks whether or not a certain time has passed since the operation button was brought close to the indicator last time (that is, since the last time Step S103 was executed) (Step S106). If a certain time has not passed since the operation button was brought close to the indicator last time (NO in Step S106), the process returns to Step S104 while maintaining the display position of each operation button. If a certain time has passed since the operation button was brought close to the indicator last time (YES in Step S106), the process returns to Step S103 to bring the display position of the operation button with the highest priority close to the latest position of the indicator.

The position of the operation button brought close to the position of the indicator in the process of Step S106 is fixed without following the movement of the indicator for a certain time. Thereby, the operator can readily operate the operation buttons other than the operation button brought close to the position of the indicator. Although the length of a certain time may be any value, it is preferably about 3 seconds, for example.

FIG. 7 is a flowchart illustrating an operation of the second display control unit 12. The operation of the second display control unit 12 will be described with reference to FIG. 7.

The second display control unit 12 first checks whether or not the indicator has approached the touch panel 1 based on the position of the indicator recognized by the indicator position recognition unit 13 (Step S201). Specifically, the second display control unit 12 checks whether or not the distance from the touch panel 1 to the indicator is smaller than a predetermined threshold value as in the same with Step S102 of FIG. 6. When the indicator has not approached touch panel 1 (NO in Step S201), Step S201 is repeatedly executed.

When the indicator has approached the touch panel 1 (YES in Step S201), the second display control unit 12 synthesizes the image being displayed on the touch panel 1 and the indicator image stored in the indicator image storage unit 121, and causes the head-up display 2 to display the obtained synthesized image (Step S202). At this time, the second display control unit 12 synthesizes the indicator image at a position corresponding to the position of the indicator recognized by the indicator position recognition unit 13 with respect to the image being displayed on the touch panel 1. As a result, the head-up display 2 displays an image as illustrated in FIG. 5 in the visual field of the operator.

In the flow of FIG. 7, the head-up display 2 displays a synthesized image of the image being displayed on the touch panel 1 and the indicator image only when the indicator has approached the touch panel 1. However, Step S201 in FIG. 7 may be omitted, and the head-up display 2 may always display a synthesized image of the image being displayed on the touch panel 1 and the indicator image.

FIG. 4 illustrates an example in which only the PLAYER button 102 is moved when the PLAYER button 102, which is the operation button with the highest priority, is brought close to the operator's finger 90. However, as illustrated in FIG. 8, the other operation buttons may be moved in the same direction as the PLAYER button 102 is moved. The PLAYER button 102 is positioned closest to the operator's finger 90. By moving all the operation buttons to the vicinity of the operator's finger 90, the operability of not only the PLAYER button 102 but also other operation buttons is improved.

However, if all the operation buttons are moved, some operation buttons (TEL button 104 in FIG. 8) may be out of the screen of the touch panel 1. In this case, the operation buttons that are out of the screen may be temporarily inoperable (this problem is solved by Embodiment 2 described later). Note that, in the state where the operation screen of FIG. 8 is displayed on the touch panel 1, the second display control unit 12 causes the head-up display 2 to display an image as illustrated in FIG. 9 in the visual field of the operator.

In FIG. 5 and FIG. 9, although the indicator image 202 the head-up display 2 displays is an image imitating the operator's finger, any image can be used as the indicator image 202. For example, the indicator image 202 may be a hand figure as illustrated in FIG. 10, or the indicator image 202 may be an arrow figure as illustrated in FIG. 11.

Further, as illustrated in FIG. 12, the indicator image 202 may be a translucent image. By making the indicator image 202 translucent, the operation button at the position overlapping the indicator image 202 is prevented from being invisible by the indicator image 202.

The present invention is applicable to a case where the operation screen displayed on the touch panel 1 has only one operation button. In that case, one operation button included in the operation screen is always “the operation button with the highest priority”.

In Embodiment 1, the priority setting unit 14 sets the priority for each operation button based on the past operation history and the method of determining the priority for each operation button may be arbitrary. For example, the user may arbitrarily set the priority for each operation button according to the user's preference. That is, the priority setting unit 14 may set the priority for each operation button according to the user's operation. In this case, the priority setting unit 14 does not need to include the operation history storage unit 141 and the next operation prediction unit 142.

Some elements of the display control device 10 may be realized in a server capable of communicating with the display control device 10. For example, in a case where a large storage capacity is secured in the operation history storage unit 141, or in a case where the calculation load of the process in which the next operation prediction unit 142 learns the operator's operation pattern or predicts the next operation is large, realizing the operation history storage unit 141 or the next operation prediction unit 142 in a server can reduce the cost because the storage capacity or calculation capacity required for the display control device 10 can be suppressed.

Further, in FIG. 1, although the touch panel 1, the head-up display 2, the proximity sensor 3, the operation recognition device 4, the information processing device 5, and the display control device 10 are illustrated as different blocks, two or more of them may be configured in an integrated manner. For example, all of them may be housed in a single housing to constitute an in-vehicle device such as a navigation device.

FIG. 13 and FIG. 14 are block diagrams illustrating examples of configurations of hardware of the display control device 10, respectively. Each element of the display control device 10 illustrated in FIG. 1 is realized by, for example, the processing circuit 50 illustrated in FIG. 13. That is, the processing circuit 50 includes the first display control unit 11 that displays an image on the touch panel 1, the second display control unit 12 that displays an image in the visual field of the operator of the touch panel 1 using the head-up display 2, and the indicator position recognition unit 13 that recognizes the position of the indicator used for the operation of the touch panel 1. The first display control unit 11 included in the processing circuit 50 includes the operation button position control unit 111 that controls the display position of the operation button when the operation button is displayed on the touch panel 1. When the distance between the touch panel 1 and the indicator becomes smaller than a predetermined threshold value, the operation button position control unit 111 brings the display position of the operation button close to the position of the indicator. The second display control unit 12 displays a synthesized image of the image being displayed on the touch panel 1 and the indicator image in the visual field of the operator using the head-up display.

Dedicated hardware may be adopted to the processing circuit 50, or a processor (also referred to as central processing unit (CPU), a processing device, an arithmetic device, a microprocessor, a microcomputer, a Digital Signal Processor (DSP)) that executes a program stored in a memory may also be adopted.

When the processing circuit 50 is dedicated hardware, the processing circuit 50 corresponds, for example, to a single circuit, a composite circuit, a programmed processor, a parallel-programmed processor, an Application Specific Integrated Circuit (ASIC), a Field-Programmable Gate Array (FPGA) or a combination thereof. Each function of each element of the display control apparatus 10 may be realized by a plurality of processing circuits, or the functions may be realized collectively by a single processing circuit.

FIG. 14 illustrates a hardware configuration of the display control device 10 when the processing circuit 50 is configured using a processor. In this case, the function of each element of the display control device 10 is realized by a combination of software or the like (software, firmware, or software and firmware). Software or the like is described as a program and stored in a memory 52. A processor 51 as the processing circuit 50 implements the functions of the respective units by reading out and executing the program stored in the memory 52. That is, the display control device 10 includes the memory 52 for storing a program that, when executed by the processing circuit 50, executes a process of displaying an image including an operation button on the touch panel 1, a process of recognizing the position of an indicator used for the operation of the touch panel 1, a process of bringing the display position of the operation button close to the position of the indicator when the distance between the touch panel 1 and the indicator becomes smaller than a predetermined threshold value, and a process of displaying a synthesized image of the image being displayed on the touch panel 1 and the image indicating the position of the indicator in the visual field of the operator of the touch panel 1 using the head-up display, eventually. In other words, it can be said that the program causes the computer to execute the operation procedure and method of each element of the display control device 10.

Here, the memory 52 may be a non-volatile or volatile semiconductor memory such as a Random Access Memory (RAM), a Read Only Memory (ROM), a flash memory, an Erasable Programmable Read Only Memory (EPROM), an Electrically Erasable Programmable Read Only Memory (EEPROM), or the like, a Hard Disk Drive (HDD), a magnetic disk, a flexible disk, an optical disk, a compact disk, a mini disk, a Digital Versatile Disc (DVD) and a drive device therefor or the like, or any storage media to be used in the future.

The configuration in which the function of each element of the display control device 10 is realized by either hardware or software has been described above. However, the configuration is not limited thereto, and a configuration in which some elements of the display control device 10 are realized by dedicated hardware and some other elements are realized by software or the like may be adopted. For example, for some elements, the functions are realized by the processing circuit 50 as dedicated hardware, and for some other elements, the processing circuit 50 as the processor 51 reads and executes a program stored in the memory 52, thereby realizing the functions thereof.

As described above, the display control device 10 can realize the above functions by hardware, software, or the like, or a combination thereof.

<Embodiment 2>

In Embodiment 1, in the operation screen displayed on the touch panel 1, although the operation button that can be brought close to the position of the indicator is always the highest priority, in Embodiment 2, the operation button brought close to the position of the indicator is changed at regular intervals. The configuration of the touch panel system 20 of Embodiment 2 may be the same as that illustrated in FIG. 1.

FIG. 15 is a flowchart illustrating an operation of the first display control unit 11 included in the display control device 10 according to Embodiment 2. The flow of FIG. 15 is obtained by adding Step S107 for changing the operation button to be brought close to the position of the indicator to the flow of FIG. 6. Step S107 is executed when YES is determined in Step S106. In Step S107, the operation button position control unit 111 brings the display position of the operation button with the second highest priority next to the operation button that was brought close to the indicator last time close to the position of the indicator. In addition, after Step S107, the process proceeds to Step S104.

With reference to FIG. 15, an operation of the first display control unit 11 included in the display control device 10 according to Embodiment 2 will be described.

In Embodiment 2, after the indicator approaches the touch panel 1 and the operation button with the highest priority is brought close to the position of the indicator (Step S103), a state where no operation button is operated with the indicator staying close to the touch panel 1 lasts for a certain time (YES in all Steps S104 to S106), the operation button position control unit 111 brings the operation button with the second highest priority close to the indicator (Step S107). At this time, the operation button with the highest priority is returned to the original position (position on the normal operation screen). Although the length of a certain time may be any value, it is preferably about 3 seconds, for example.

After that, when the state where no operation button is operated with the indicator staying close to the touch panel 1 lasts for a certain time (YES in all Steps S104 to S106), Step S107 is executed, and the operation button position control unit 111 brings the operation button with the next highest priority, that is, the operation button with the third highest priority close to the indicator. At this time, the operation button with the second highest priority is returned to the original position (position on the normal operation screen).

After that, if YES is determined in all of Steps S104 to S106, Step S107 is executed, in replace of the operation button that was brought close to the indicator last time, the operation button position control unit 111 brings the operation button with the next highest priority close to the indicator. However, if the operation button brought close to the indicator last time is the one with the lowest priority, it returns to the beginning, and the operation button position control unit 111 brings the operation button with the highest priority close to the indicator.

Here, FIG. 3 illustrates the normal operation screen and it is assumed that the priority of each operation button is higher in the order of the PLAYER button 102, the RADIO button 103, the NAVI button 101, and the TEL button 104. In this case, in Embodiment 2, the operation screen displayed on touch panel 1 changes as illustrated in FIG. 16. That is, when the operator brings the finger 90 close to the touch panel 1, first, the PLAYER button 102 with the highest priority moves to the position of the finger 90. Thereafter, when a certain time has passed without the operation button being operated while the finger 90 stays close to the touch panel 1, the RADIO button 103 with the second highest priority moves to the position of the finger 90. Further, when a certain time has passed, the NAVI button 101 with the third highest priority moves to the position of the finger 90. Further, when a certain time has passed, the TEL button 104 with the lowest priority moves to the position of the finger 90. Further, when a certain time has passed, the PLAYER button 102 with the highest priority moves to the position of the finger 90, again.

Note that, the operation of the second display control unit 12 may be the same as that of Embodiment 1 (FIG. 7). When the operation screen displayed on the touch panel 1 changes as illustrated in FIG. 16, in synchronization with the change, the image the head-up display 2 displays in the operator's visual field (display area 2a) also changes as illustrated in FIG. 17.

According to Embodiment 2, as long as the operator holds the indicator close to the touch panel 1, the operation buttons that can be brought close to the position of the indicator are switched in order of higher priority at regular intervals. Therefore, even if the operation button that first approaches the indicator is not the desired one, the desired operation button approaches the indicator after a while. Therefore, the operator can operate any desired operation buttons with a few finger movements.

Also in Embodiment 2, as illustrated in FIG. 8, all the operation buttons may be moved in the same direction. When the operation screen displayed on the touch panel 1 changes as illustrated in FIG. 18, in synchronization with the change, the image the head-up display 2 displays in the operator's visual field changes as illustrated in FIG. 19. In Embodiment 2, even if a desired operation button is out of the screen of the touch panel 1, the operation button is displayed near the indicator (in the screen of the touch panel 1) and can be operated after a while.

<Embodiment 3>

In Embodiment 2, changing the operation button that is brought close to the position of the indicator requires a certain time, however, in Embodiment 3, the operator can actively change the operation button that is brought close to the position of the indicator. The configuration of the touch panel system 20 of Embodiment 3 may be the same as that illustrated in FIG. 1.

FIG. 20 is a flowchart illustrating an operation of the first display control unit 11 included in the first display control unit 11 according to Embodiment 3. The flow of FIG. 20 is obtained by adding Step S108 for checking whether or not an amount of change (movement amount) of the indicator has reached a certain value since the operation button was brought close to the position of the indicator last time to the flow of FIG. 15.

In Embodiment 3, after the indicator approaches the touch panel 1, even if the state where the operation button is not operated has not lasted for a certain time (NO in Step S106), if the amount of movement of the indicator reaches a certain value (YES in Step S108) by the operator shaking the indicator right and left, etc. Step S107 is executed, and the operation button position control unit 111 changes the operation button that approaches the indicator. That is, in replace of the operation button that was brought close to the indicator last time, the operation button with the next highest priority is brought close to the indicator. In Step S108, if the amount of movement of the indicator has not reached a certain value (NO in Step S108), the process proceeds to Step S104.

As described above, in Embodiment 3, while the touch panel 1 approaches the indicator and a plurality of operation buttons have not been operated, the operation button position control unit 111 keeps on changing the operation button that approaches the position of the indicator every time the amount of movement of the indicator reaches a certain value.

In an example of FIG. 3 for example, assuming that the priority setting unit 14 assigns a higher priority in the order of the PLAYER button 102, the RADIO button 103, the NAVI button 101, and the TEL button 104, the operation screen displayed in the touch panel 1 changes in the same order as in FIG. 16 (or FIG. 18) every time the amount of movement of the indicator reaches a certain value.

The operation of the second display control unit 12 may be the same as that of Embodiment 1. When the operation screen displayed on the touch panel 1 changes as illustrated in FIG. 16 (or FIG. 18), in synchronization with the change, the image the head-up display 2 displays in the operator's visual field (display area 2a) also changes as illustrated in FIG. 17 (or FIG. 19).

According to the touch panel system 20 of Embodiment 3, the operation button that is brought close to the position of the indicator is changed when the amount of change in the position of the indicator reaches a certain value, for example, by the operator shaking the indicator right and left or the like. Therefore, the operator can change the operation button that is brought close to the position of the indicator more quickly than Embodiment 2.

<Embodiment 4>

In Embodiment 4, when the position of the indicator approaching the touch panel 1 overlaps the display position of any operation button, the second display control unit 12 displays an image of a screen slated to be displayed in the touch panel 1 (hereinafter referred to as “next screen”) if the operation button is operated in the visual field of the operator using a head-up display.

FIG. 21 is a functional block diagram illustrating a configuration of a touch panel system 20 according to Embodiment 4. The configuration of FIG. 21 is obtained by adding a next screen image storage unit 122 to the second display control unit 12 of the display control device 10 in FIG. 1. The next screen image storage unit 122 stores an image of the next screen corresponding to each operation button. The next screen image storage unit 122 may acquire and store an image of the next screen corresponding to each operation button from the information processing device 5, or may extract and store an image of the next screen corresponding to each operation button from the past display history of the touch panel 1.

FIG. 22 is a flowchart illustrating an operation of the first display control unit 11 in Embodiment 4. The flow of FIG. 20 is obtained by adding Step S203 for checking whether or not the position of the indicator overlaps the operation button and Step S204 for causing the head-up display 2 to display an image of the next screen corresponding to the operation button overlapping the indicator to the flow of FIG. 7.

Referring to FIG. 22, an operation of the second display control unit 12 according to Embodiment 4 will be described. First, the second display control unit 12 checks whether or not the indicator has approached the touch panel 1 (Step S201). If the indicator has not approached touch panel 1 (NO in Step S201), Step S201 is repeatedly executed.

If the indicator has approached the touch panel 1 (YES in Step S201), the second display control unit 12 checks whether or not the position of the indicator overlaps the operation button (Step S203).

If the position of the indicator overlaps the operation button (YES in Step S203), the second display control unit 12 causes the head-up display 2 to display the image of the next screen corresponding to the operation button on the image being displayed on the touch panel 1 (Step S204). For example, when the position of the indicator overlaps the PLAYER button 102 as illustrated in FIG. 4, a next screen image 203 (an execution screen for media playback function) corresponding to the PLAYER button 102 is displayed in the visual field of the operator as illustrated in FIG. 23.

Meanwhile, if the position of the indicator does not overlap the operation button (NO in Step S203), the second display control unit 12 synthesizes the indicator image stored in the indicator image storage unit 121 and the image being displayed on the touch panel 1, as in Embodiment 1, and causes the head-up display 2 to display the thus obtained synthesized image (Step S202). For example, as illustrated in FIG. 24, if the position of the indicator does not overlap any operation buttons, a synthesized image of the image 201 being displayed on the touch panel 1 and the indicator image 202 is displayed in the visual field of the operator as illustrated in FIG. 25.

According to Embodiment 4, when the position of the indicator overlaps the operation button, the head-up display 2 displays the next screen image corresponding to the operation button overlapping the position of the indicator. Therefore, the operator can intuitively grasp which operation button is displayed under the indicator from the image displayed by the head-up display 2.

It should be noted that the next screen image stored in the next screen image storage unit 122 is not necessarily to be the actual next screen itself, and it only needs to be the one intuitively understood in what screen it is going to be shifted to, when the operation button that overlaps the position of the indicator is operated. For example, in replace of the image 203 of the next screen illustrated in FIG. 23, an image 203a, which is an image obtained by simplified the actual next screen (an execution screen for media playback function) as illustrated in FIG. 26, may be used.

It should be noted that Embodiments of the present invention can be arbitrarily combined and can be appropriately modified or omitted without departing from the scope of the invention.

While the invention has been described in detail, the forgoing description is in all aspects illustrative and not restrictive. It is understood that numerous other modifications and variations that are not exemplified can be devised without departing from the scope of the invention.

### EXPLANATION OF REFERENCE SIGNS

1 touch panel, 1a display unit, 1b touch sensor, 2 head-up display, 2a display area, 3 proximity sensor, 4 operation recognition device, 5 information processing device, 10 display control device, 11 first display control unit, 111 operation button position control unit, 12 second display control unit, 121 indicator image storage unit, 122 next screen image storage unit, 13 indicator position recognition unit, 14 priority setting unit, 141 operation history storage unit, 142 next operation prediction unit, 20 touch panel system, 50 processing unit, 51 processor, memory, 90 operator's finger, 101 NAVI button, 102 PLAYER button, 103 RADIO button, 104 TEL button, 201 image being displayed on touch panel, 202 indicator image, 203 next screen image.

1-24. (canceled)

25. A display control device comprising:
a processor to execute a program; and
a memory to store the program which, when executed by the processor, performs processes of,
displaying an image including an operation button on a touch panel;
recognizing a position of an indicator used for an operation of the touch panel;
when a distance between the touch panel and the indicator becomes smaller than a predetermined threshold value, bringing the display position of the operation button close to the position of the indicator, and displaying a synthesized image of an image being displayed on the touch panel and an image indicating the position of the indicator in the visual field of an operator of the touch panel using a head-up display.

26. The display control device according to claim 25, wherein
the processor fixes the display position of the operation button brought close to the position of the indicator without following a change in the position of the indicator.

27. The display control device according to claim 25, wherein,
when the position of the indicator overlaps the display position of the operation button, the processor displays an image of a screen that is slated to be displayed on the touch panel when the operation button is operated or an image of the screen that is simplified thereof is displayed in the visual field of the operator using the head-up display.

28. The display control device according to claim 25, wherein
the processor displays a plurality of the operation buttons on the touch panel, and
when the distance between the touch panel and the indicator becomes smaller than the predetermined threshold value, the processor brings a display position of at least one of the plurality of the operation buttons close to the position of the indicator.

29. The display control device according to claim 28, wherein
the processor fixes the display position of the operation button brought close to the position of the indicator without following a change in the position of the indicator.

30. The display control device according to claim 28, wherein
when a state where the distance between the touch panel and the indicator is smaller than the predetermined threshold value and none of the plurality of the operation buttons are operated lasts, the processor changes the operation button to be brought close to the position of the indicator every time a certain time passes.

31. The display control device according to claim 30, wherein
the processor sets a priority of each of the plurality of the operation buttons, and
the processor brings the operation buttons close to the position of the indicator in order from the highest priority.

32. The display control device according to claim 28, wherein
when a state where the distance between the touch panel and the indicator is smaller than the predetermined threshold value and none of the plurality of the operation buttons are operated lasts, the processor changes the operation button to be brought close to the position of the indicator every time an amount of change of the position of the indicator reaches a certain value.

33. The display control device according to claim 32, wherein
the processor sets a priority of each of the plurality of the operation buttons, and
the processor brings the operation buttons close to the position of the indicator in order from the highest priority.

34. The display control device according to claim 28, wherein,
when the position of the indicator overlaps any of the display positions of a plurality of the operation buttons, the processor displays an image of a screen that is slated to be displayed on the touch panel when the operation button overlapping the indicator is operated or an image of the screen that is simplified thereof is displayed in the visual field of the operator using the head-up display.

35. A display control device comprising:
a processor to execute a program; and
a memory to store the program which, when executed by the processor, performs processes of,
displaying an image including an operation button on a touch panel;
recognizing a position of an indicator used for an operation of the touch panel;
when a distance between the touch panel and the indicator becomes smaller than a predetermined threshold value, bringing the display position of the operation button close to the position of the indicator, and
when the position of the indicator overlaps the display position of the operation button, displaying an image of a screen that is slated to be displayed on the touch panel when the operation button is operated or an image of the screen that is simplified thereof is displayed in the visual field of an operator of the touch panel using the head-up display.

36. The display control device according to claim 35, wherein
the processor fixes the display position of the operation button brought close to the position of the indicator without following a change in the position of the indicator.

37. The display control device according to claim 35, wherein
the processor displays a plurality of the operation buttons on the touch panel,
when the distance between the touch panel and the indicator becomes smaller than the predetermined threshold value, the processor brings a display position of at least one of the plurality of the operation buttons close to the position of the indicator, and
when the position of the indicator overlaps any of the display positions of a plurality of the operation buttons, the processor displays an image of a screen that is slated to be displayed on the touch panel when the operation button overlapping the indicator is operated or an image of the screen that is simplified thereof is displayed in the visual field of the operator using the head-up display.

38. The display control device according to claim 37, wherein
the processor fixes the display position of the operation button brought close to the position of the indicator without following a change in the position of the indicator.

39. The display control device according to claim 37, wherein
when a state where the distance between the touch panel and the indicator is smaller than the predetermined threshold value and none of the plurality of the operation buttons are operated lasts, the processor changes the operation button to be brought close to the position of the indicator every time a certain time passes.

40. The display control device according to claim 39, wherein
the processor sets a priority of each of the plurality of the operation buttons, and
the processor brings the operation buttons close to the position of the indicator in order from the highest priority.

41. The display control device according to claim 37, wherein
when a state where the distance between the touch panel and the indicator is smaller than the predetermined threshold value and none of the plurality of the operation buttons are operated lasts, the processor changes the operation button to be brought close to the position of the indicator every time an amount of change of the position of the indicator reaches a certain value.

42. The display control device according to claim 41, wherein
the processor sets a priority of each of the plurality of the operation buttons, and
the processor brings the operation buttons close to the position of the indicator in order from the highest priority.

43. A display control method, comprising the steps of:
displaying an image including an operation button on a touch panel;
recognizing a position of an indicator used for an operation of the touch panel;
when a distance between the touch panel and the indicator becomes smaller than a predetermined threshold value, bringing the display position of the operation button close to the position of the indicator; and
displaying a synthesized image of an image being displayed on the touch panel and an image indicating the position of the indicator in the visual field of an operator of the touch panel using a head-up display.
